(19) United States
(12) Patent Application Publication
(10) Pub. No.: US 2005/0021428 A1
(43) Pub. Date: Jan. 27, 2005

(54) Time management system for mobile employees

(76) Inventor: Charles T. Costello, Amston, CT (US)

Correspondence Address: LITMAN LAW OFFICES, LTD., P.O. BOX 15035 CRYSTAL CITY STATION, ARLINGTON, VA, 22215, US

(21) Appl. No.: 10/611,273

(22) Filed: Jul. 2, 2003

(51) Int. Cl. G06F 17/60

(52) U.S. Cl. 705/32

(57) ABSTRACT

The time management system for mobile employees is a telecommunications system allowing a company client to manage their off-site employees efficiently and effectively. Mobile employees, in communication with the system Web server via a cell phone or PDA, enter time transaction data using the mobile computing device's Web browser. Based upon the employee's predefined profile, custom Web pages are presented requesting employee specific time transaction information. Once received, time transaction data may be forwarded to the company client's computer directly or downloaded to client computers upon request or based upon a predetermined schedule. Having at least one Web server and application/database server, the system maintains employee data, client data, project data, and transaction data. The system protects against unauthorized access of data by having defined administrative user privileges.

### BACKGROUND OF THE INVENTION

1. Field of the Invention

The present invention relates generally to time clocks systems. More specifically, the invention is a computerized time management system for the efficient and effective time management of mobile employees while at work locations remote from the central office.

2. Description of the Related Art

Systematic and accurate time keeping for hourly employees is an essential and often a required function for most businesses. Time records are needed for the generation of payroll and tax information, and often used in preventing time keeping abuse by employees. Computers have long since made the task of processing the individual time records of employees less time consuming. Traditionally, computer systems have used punched cards for entering the time data for each employee. Once the data has been entered into the computer memory, the data may be processed and manipulated to quickly generate a number of reports. The advent of personal computers and inexpensive software has enabled many companies to streamline their time recording and payroll processes while increasing efficiency. Many small companies, however, lacking computer resources, have turned to payroll processing companies, which, on a fee for service basis, will provide both the software and services required to enter and process the time data.

U.S. Pat. No. 4,819,162, issued to Webb, Jr. et al. in 1989, discloses a computerized time clock system including a computer through which employee, job and schedule records may be assembled and maintained. A remote computerized time clock interfaced with the computer is utilized by employees for time-in and time-out transactions.

U.S. Pat. Nos. 5,459,657 and 5,717,867, issued to Wynn et al. in 1995 and 1998, respectively, disclose a time entry and accounting system permitting employees to clock in and clock out from work at computerized time clocks located adjacent to their workstations using an individually encoded identification card.

The integration of telecommunication technology and computer technology as well as the increasing magnitude of the mobile workforce has expanded the need for more sophisticated devices and methods for tracking time and location of personnel in a mobile environment.

U.S. patent Publication No. US 2002/0145559, published in 2002, discloses an automated time and location system having a smart GPS receiver and a data transmitter, such as a cellular telephone, for tracking employees away from a central location. Time and location data are sent to a base station from the transmitter, which may be activated automatically on a schedule, or by a query signal from the base station. The device however, does not allow the user to initiate the cellular call, nor does the system allow the user to enter in-task duration data.

U.S. Pat. No. 5,963,912, issued to Katz in 1999, shows a computer system interfaced with the phone system for accepting incoming phone calls providing arrival, departure, and other time-related information from field based employees at various work sites.

U.S. Pat. No. 6,154,727, issued to Karp et al. in 2000, describes a system for tracking clients as they visit various locations. The clients have access to telephones and identification devices, which the clients can use to communicate with a remote computer. The computer uses information, including biometric data, received during the communication to identify and authenticate the client making the communication and the location of the client at the time of the communication. The location of the caller is traced using the automatic number identification (ANI) of the calling number, or uses information provided by the cellular carrier to identify the origin of the call when the client is using a cellular telephone. U.S. Pat. Nos. 6,259,780 and 6,463,138, both issued to Sherwood et al. in 2001 and 2002, respectively, disclose a system for formatting caller ID information into a form usable by an application program and then exporting the caller ID information to the application program.

With the advent of the Internet, online services, advances in internetworking, and mobile communication, devices are now available for integrating mobile communication with the capability of accessing remote computers and the Internet. U.S. Pat. No. 6,243,596, issued to Kikinis in 2001, discloses a battery pack of a cellular telephone having additional elements that provide the functionality of an Internet browser.

U.S. patent Publication No. 2001/0034229, published in 2001, discloses a personal digital assistant (PDA) and telephone combination device capable of accessing the Internet and retrieving E-mails.

An additional remote user device disclosed in U.S. patent Publication No. 2003/0005056 published in 2003, describes a mobile information terminal device, which presents, on that device, the user's own schedule information residing on a remote network.

Additional devices providing both mobile voice communications and integrated data terminal capabilities include U.S. patent Publication No. 2002/0077156 published in 2002, U.S. patent Publication No. 2002/0155820, published in 2002, U.S. patent Publication No. 2003/0040346, published in 2003, and PCT Application No. WO 97/50264, published in 1997.

U.S. Pat. No. 5,815,556, issued to Thuresson et al. in 1998, discloses a computer-based telecommunications system utilizing an object oriented processing system for exchanging data between databases and customers connected thereto. The '556 patent however, does not suggest an intermediary system which forwards received data from one type of user to another. A further apparatus which integrates computers and telecommunication systems is disclosed in U.S. Pat. No. 6,215,995, issued to Perdomo in 2001, which presents a wireless subscriber unit within a wireless communication system, having a function key for performing a remote function.

None of the above inventions and patents, taken either singly or in combination, is seen to describe the instant invention as claimed. Thus a time management system enabling employees to enter time transaction data from locations remote from their office, thereby solving the aforementioned problems, is desired.

### SUMMARY OF THE INVENTION

The time management system for mobile employees is an Internet based system which allows supervising personnel at a corporate office to manage their off-site and mobile employees more efficiently and effectively. Using a mobile transmitting device, such as a cellular phone or a personal data assistant (PDA) , the employee transmits time records to a data server on the Internet which stores the time transaction data in a database for further submission to the employee's preexisting corporate time management computer systems.

The mobile employee initiates a time transaction session by first connecting to the system's Internet Web site via their mobile computing device. Upon accessing the Web site, the employee enters a screen name and password using the mobile phone keypad to gain access to a secure server with timekeeping software. Once logged-on, the employee selects the appropriate activity and client from scrolling menus displayed on the mobile computing device's screen to enter time-related information, or to receive information stored on the server regarding the task performed. The system stores the data in the form of datasets, the data schema being predefined by parameters stored in the database, thereby allowing the system to support the transmission of multiple data file formats as required by the specific application software of the client.

Once the time transaction data has been stored on the server, authorized personnel can access the secure Web site, and generate a time transaction query based upon user-selected parameters for the employee, date, client, and service performed. Upon completion of the query, an authorized user may then download the stored data onto their computers.

Time transaction data can also be downloaded to the client's existing time accounting systems. The interface to the client's time accounting systems is flexible and adaptable to the specific data interface requirements of the client's application. All data passes through Web services, thus allowing any interface to adapt to the method required by the client.

Accordingly, it is a principal object of the invention to provide at least one server computer having an interface to a computer network for the purpose of receiving time records from mobile computing devices connected to the computer network via a telecommunications network, and subsequent transmission of the time records to at least one network-connected remote client computer.

It is another object of the invention to present to send and receive data to and from cellular telephones and personal data assistants via web pages.

It is a further object of the invention to allow authorized client users to query the stored time transaction data and download the data to their own computers and applications.

Still another object of the invention is to provide a system that will facilitate the secure transfer of data from employees of multiple clients in the file format required by each client.

It is an object of the invention to provide improved elements and arrangements thereof for the purposes described which is inexpensive, dependable and fully effective in accomplishing its intended purposes.

These and other objects of the present invention will become readily apparent upon further review of the following specification and drawings.

### BRIEF DESCRIPTION OF THE DRAWINGS

FIG. 1 is a block diagram of an Internet system for time management of mobile employees according to the present invention.

FIG. 2 is an entity relationship block diagram representing the relationship between the data elements according to the Internet service of FIG. 1.

FIG. 3 is dataflow diagram representing the relationship between the system processes and the external interfaces according to the Internet service of FIG. 1.

FIG. 4A is a screenshot of a login screen for a cell phone according to the present invention.

FIG. 4B is a screenshot, of a date entry screen for a cell phone according to the present invention.

FIG. 4C is a screenshot of a client entry screen for a cell phone according to the present invention, presenting a pull-down list of available clients for the particular employee.

FIG. 4D is a screenshot of a screen display for a cell phone after client selection according to the present invention.

FIG. 4E is a screenshot of a project selection screen for a cell phone according to the present invention.

FIG. 4F is a screenshot of a time duration entry for a cell phone according to the present invention.

FIG. 4G is a screenshot of a completed transaction verification screen from a cell phone according to the present invention.

FIG. 5A is a diagrammatic view of a login screen for a PDA according to the present invention.

FIG. 5B is a diagrammatic view of a client entry selection screen for a PDA according to the present invention.

FIG. 5C is a diagrammatic view of the screen display after client selection according to the present invention.

FIG. 5D is a diagrammatic view of a project entry screen for a PDA according to the present invention.

FIG. 5E is a diagrammatic view of a date entry screen for a PDA according to the present invention.

FIG. 5F is a diagrammatic view of a time duration entry screen for PDA according to the present invention.

Similar reference characters denote corresponding features consistently throughout the attached drawings.

### DETAILED DESCRIPTION OF THE PREFERRED EMBODIMENTS

The present invention is an Internet-based time management system for mobile employees, which allows supervising personnel at a corporate office to manage their off-site and mobile employees more efficiently and effectively by enabling mobile employees to enter time transactions directly into client computer systems by means of mobile computing devices connected via the Internet to the system of the present invention, which is network connected to the client's computers.

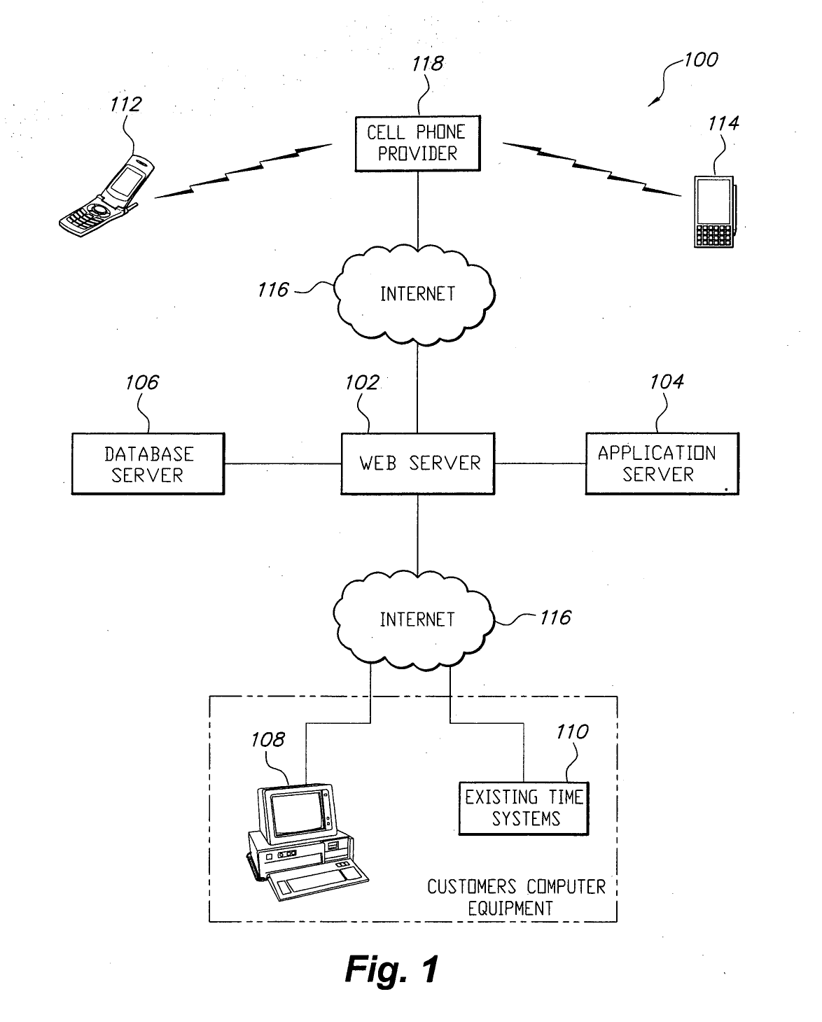

As shown in the block diagram of FIG. 1, the time management system 100, hereafter referred to as the “System”, utilizes network server technology to provide the functions of Web server 102, application server 104, and database server 106 at a host location, the host computer hardware having network connections to mobile computing devices as well as remote client computers 108, 110. The mobile computing devices may be cellular telephones 112, PDA's 114 or any mobile computing device that can establish a data connection with the Internet 116. The cellular provider 118 establishes the data connection between the mobile computing device 112, 114 and the Internet 116.

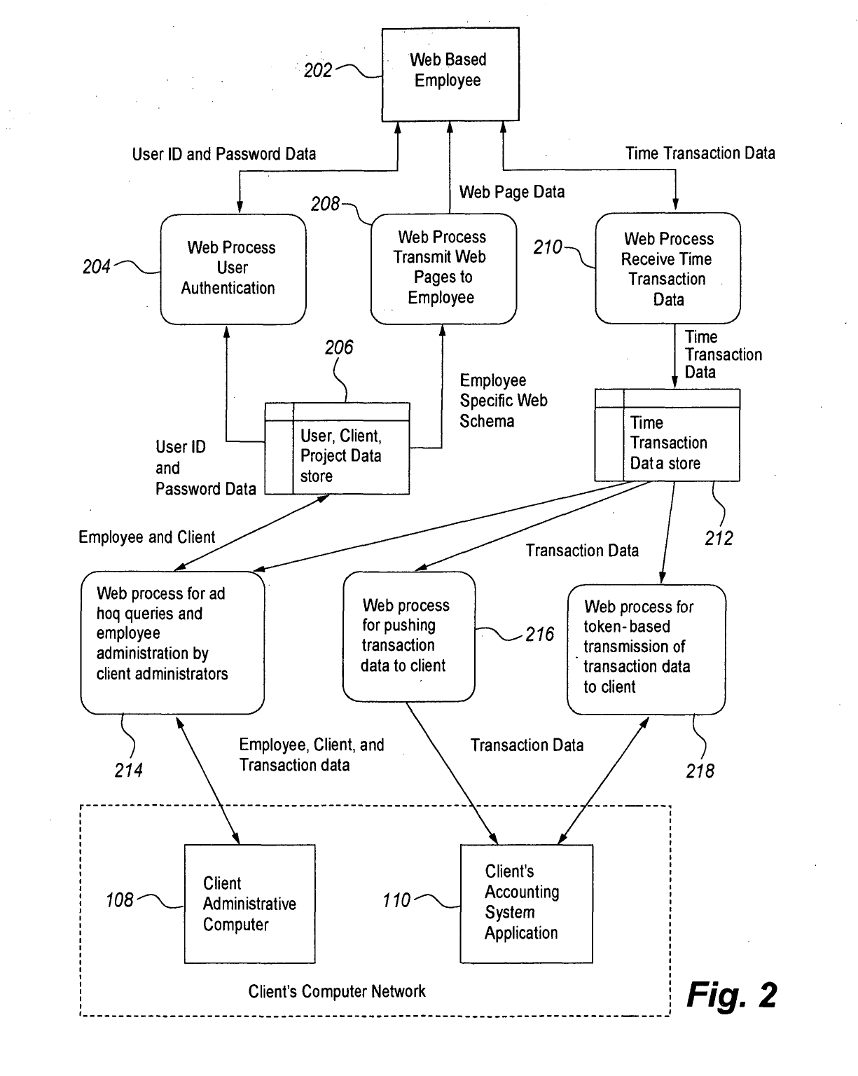

A dataflow diagram of the System is shown in FIG. 2 and illustrates the flow of data between the remote employees 202, the time management System 100 and the client's computers 108, 110. An employee 202 initiates a time transaction by accessing the System Web site using a cellular telephone 112 or personal data assistant 114. Upon accessing the Web site, the employee 202 must enter a username and password using the mobile phone keypad to gain access to time management functions of the secure server. A username and password validation process 204 enabled by employee profile information stored on a database 206 ensures the authentication of the employee. An application process 208 then determines the correct Web options for the employee based upon the stored profile 206, and presents the employee with a Web screen to enter a time transaction, or a series of screens to associate time duration with a specific project. The System 100 is not limited to a particular operating system, manufacturer or software provider, and may use any hardware, operating system, programming language, and conventional proprietary software capable of transmitting Web pages via wireless known to those skilled in the art.

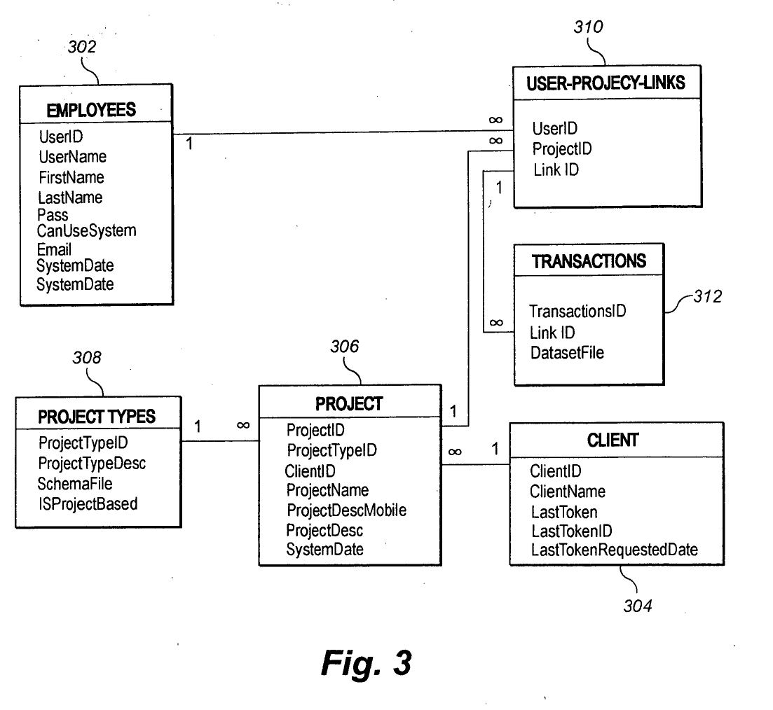

A Web process 210 receives the time transaction data entered by the employee and stores the received data in the time transaction data store (database) 212. The stored data relates to employee information, date of entry, client, and the service or project performed. The System 100 stores the data in the form of datasets, the data schema predefined by parameters stored in the employee and client database, thereby allowing the System 100 to support the transmission of multiple data file formats as required by the specific application software of the client. The data elements embodied in the System 100 are further identified in the entity relationship diagram of FIG. 3 to be described later. Once the employee has completed the time transaction, and the transaction submitted to the Web service 210, the employee will be left with either an option to close the application, or enter another time transaction.

The present System 100 has two types of client interfaces, which include computers operated by the client's administrative users 108 for generating ad hoc queries directed to the database, and existing accounting systems 110 operated by the client or by his third party agents. System processes 214, 216, and 218 are Web processes that control the flow of transaction data to the client's computer applications as well as for receiving administrative data from the client for updating the information pertinent to both the client themselves as well as employees.

Depending upon the client's particular software application, an employee's time transaction may result in either a push or a pull transaction in regards to the client's computer systems 108, 110. If the transaction is a push transaction, the system process 216 will attempt to forward the time transaction to the associated Web service.

If the transaction is a pull transaction, the System 100 stores the data and waits for a client application to request data by sending a token. Upon receiving a request for data message, the process 218 extracts the token from the message and uses the token for marking for deletion all transactions behind the token, creating a dataset of all transactions in the data store 212 between the token and the latest transaction. A new token is created and is transmitted to the client computer along with the dataset. The System 100 will then wait for the next token to be sent. If the client application fails on import, it only needs to retransmit the original token.

Once the time transaction data has been stored in the data store 212, a Web process 214 enables authorized personnel to access the secure Web site, build and transmit a database query based upon parameters which include, but are not restricted to, the employee, date, client, and service performed. Upon completion of the query, an authorized user may then download the stored data to their computers 108. The query and download privileges of the client users are stored in the database 206 to prevent unauthorized access to information.

The interface to the client's time accounting systems 110 is flexible and is adaptable to the specific data interface requirements of the client's application. The System 100 stores the time transactions in the form of datasets, which in the present embodiment are standard Extended Markup Language (XML) schemas. In order to allow the System 100 to interface with multiple existing time systems, the database stores the schema information for any given transaction type, allowing the System 100 to support any combination of datasets. Furthermore, server data can be automatically downloaded by hour, day, week, bi-weekly, monthly, quarterly or yearly period.

All data passes through non-propriety Web services, thus allowing any interface to the methods. This will allow for maximum flexibility as new requirements for the System 100 arise.

The entity relationship diagram shown in FIG. 3 illustrates the relationship between the data elements stored in the System database 106. Employee data 302 defines each employee profile and is uploaded into the System 100 by the client or the administrators of the System 100. The profile of each employee contains, at minimum, authentication information for validating the access privileges of the employee at login.

Client information 304 maintained in the database comprises the client's name, identifier, as well as information regarding the last token used in the most recent download of data. Each client has at least one project associated with it and each project must have one and only one project type associated with any one project. Project related information is stored in a “Project” data store 306 and a “Project_Types” data store 308.

Because the System 100 can support multiple clients, each with their own group, of employees, it is critical that each employee can only enter data for projects and clients to which they have been authorized. A “User_Project_Links” data store 310 is populated with all allowable combinations of employees and projects. One-to-many relationships, primary keys and the enforcement of cardinality rules ensure that the System 100 maintains the separation of data between clients.

Finally, the data collected for each transaction is maintained in a “Transactions” data store 312, which contains the employee, a pointer to the specific project and client, and the date and time duration data stored in a transaction dataset file.

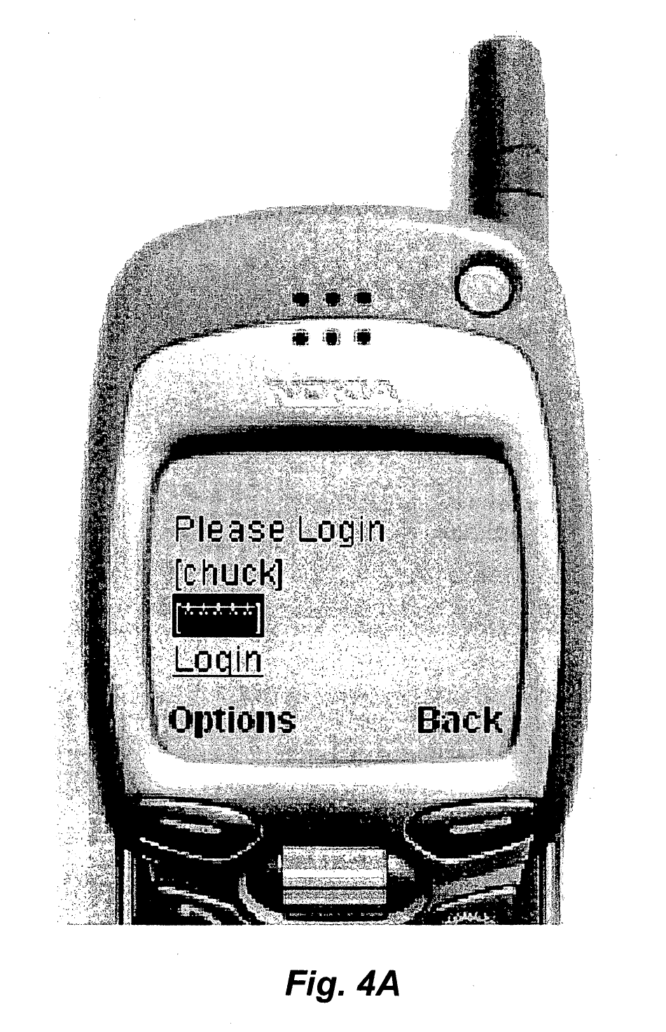

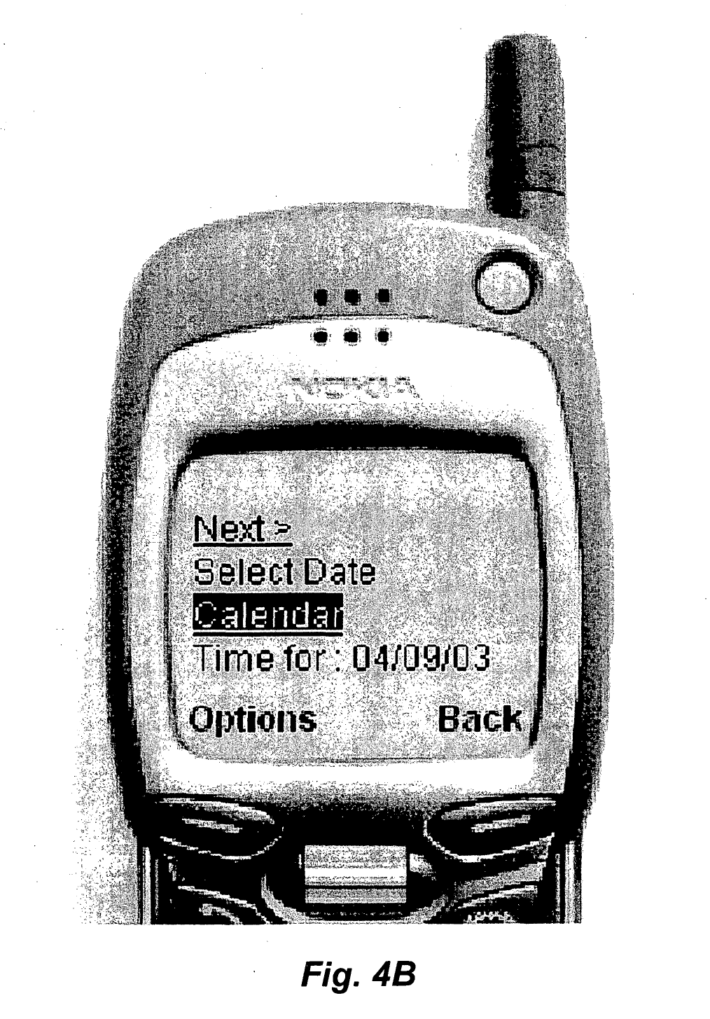

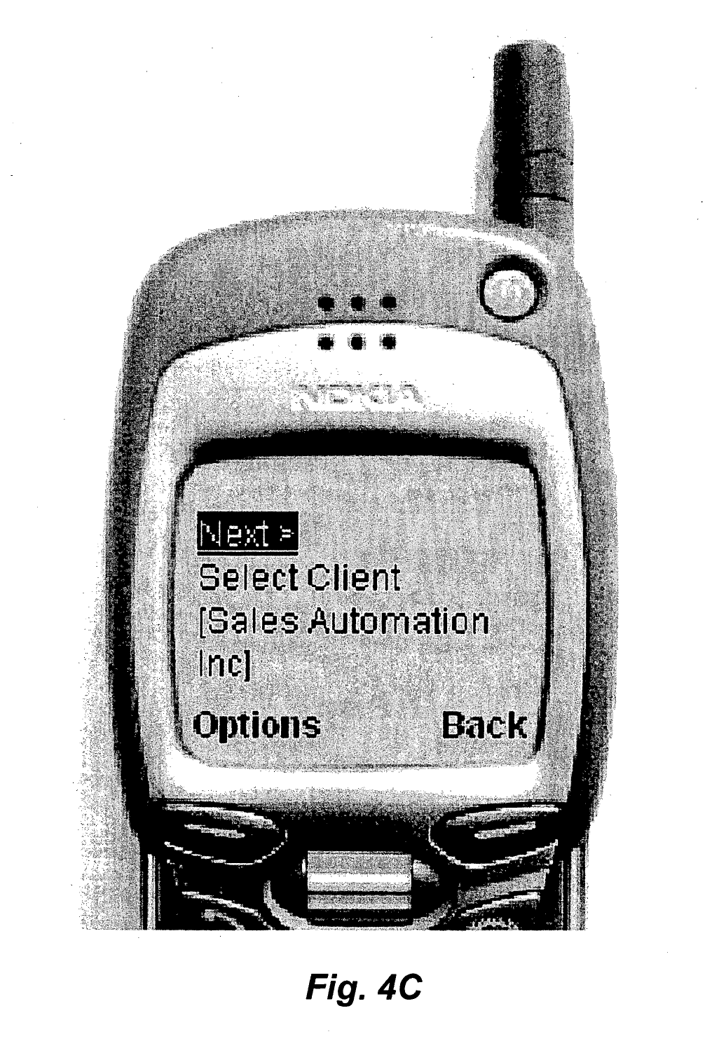

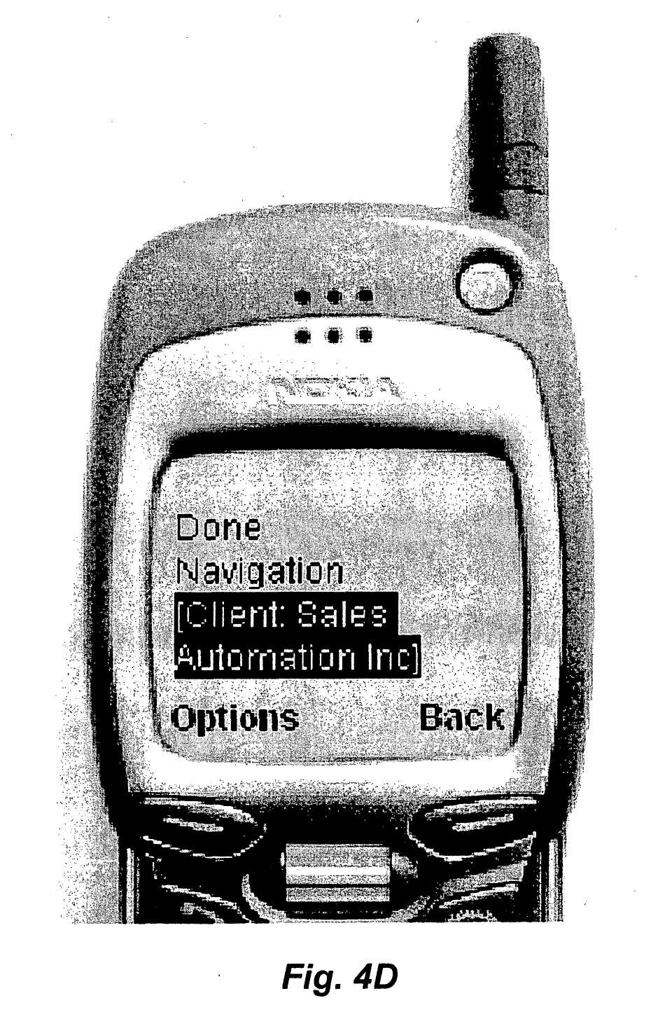

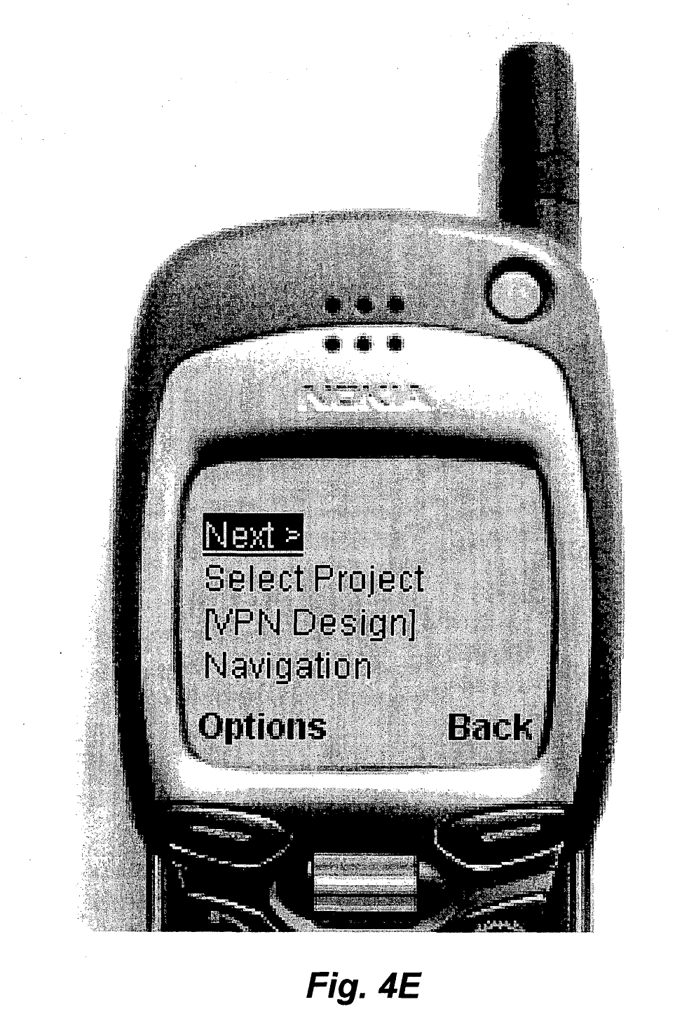

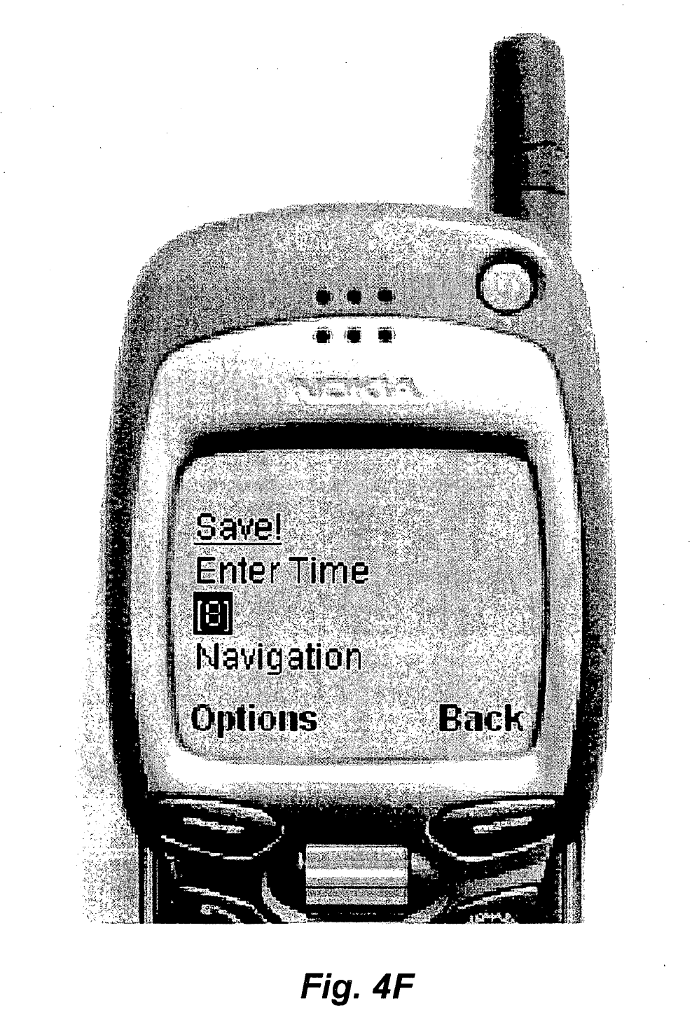

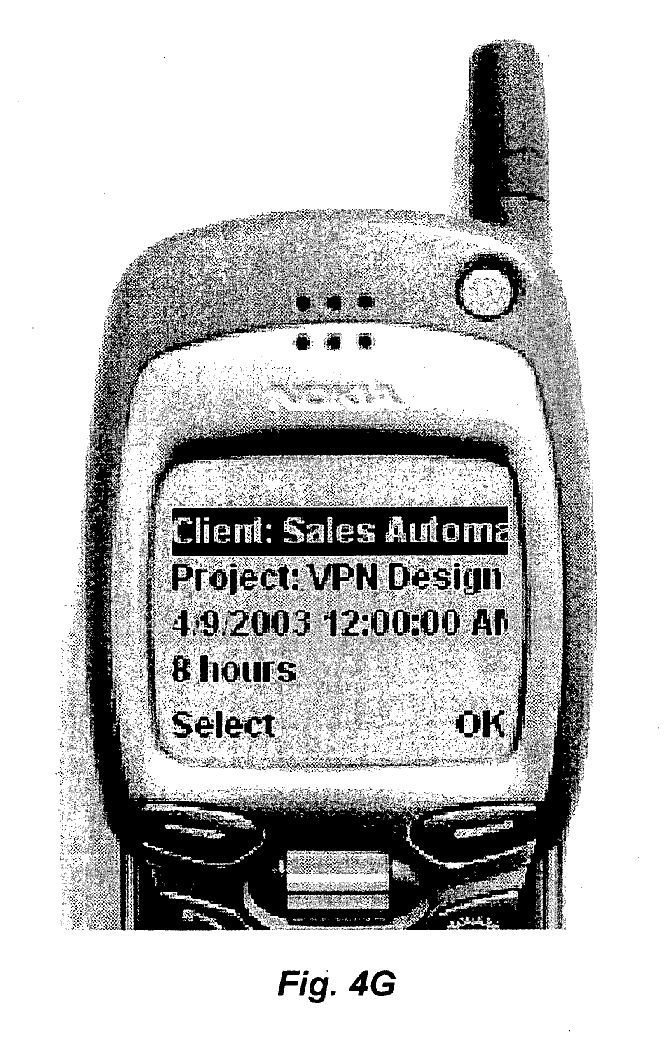

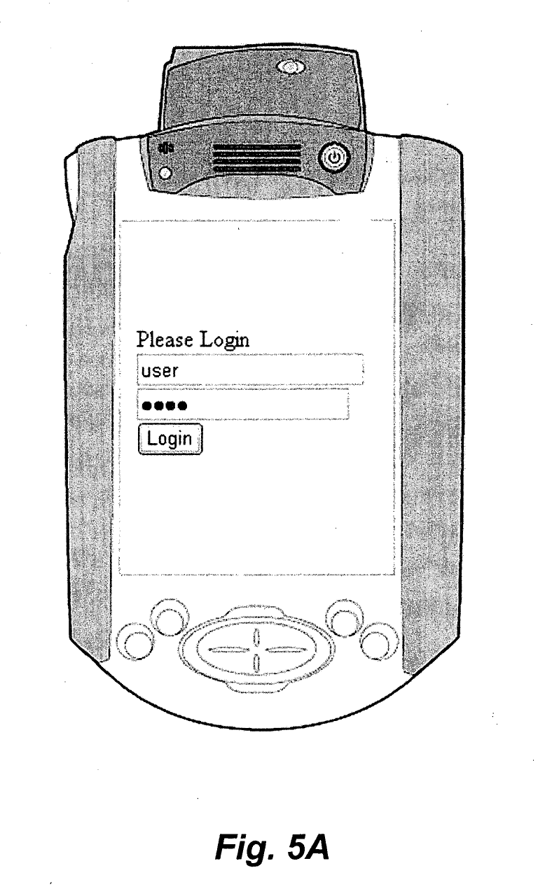

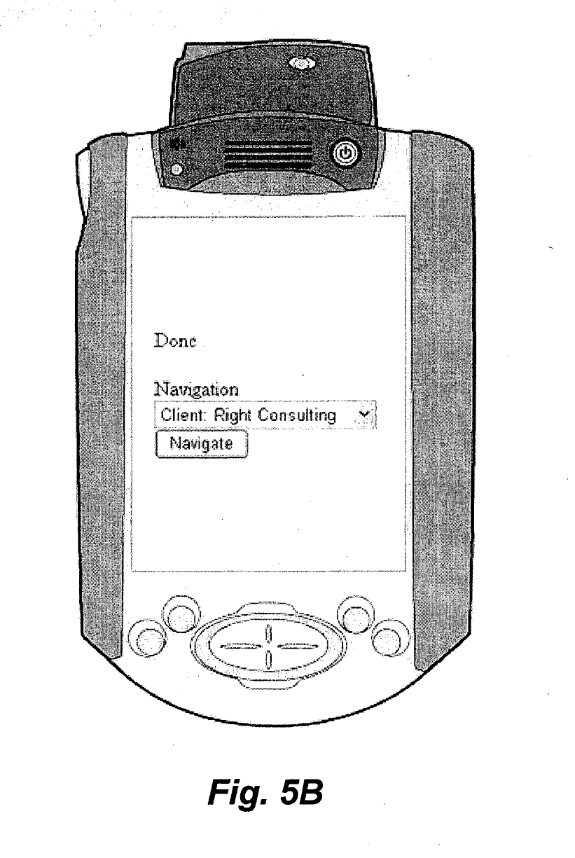

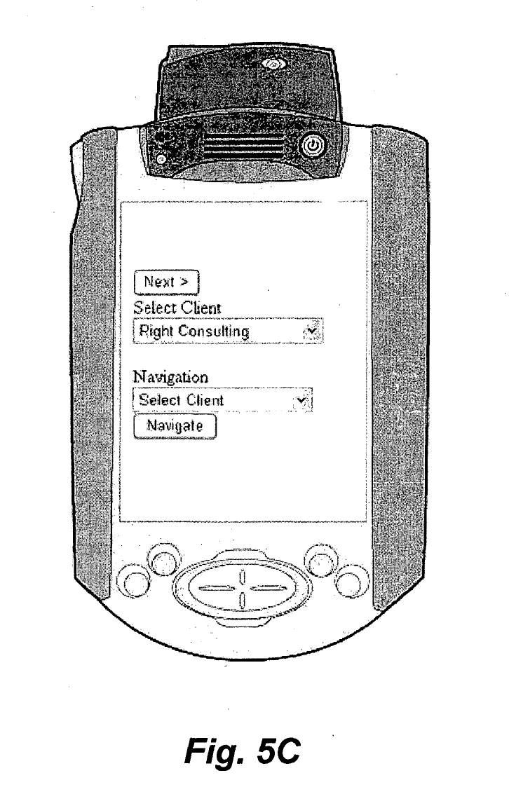

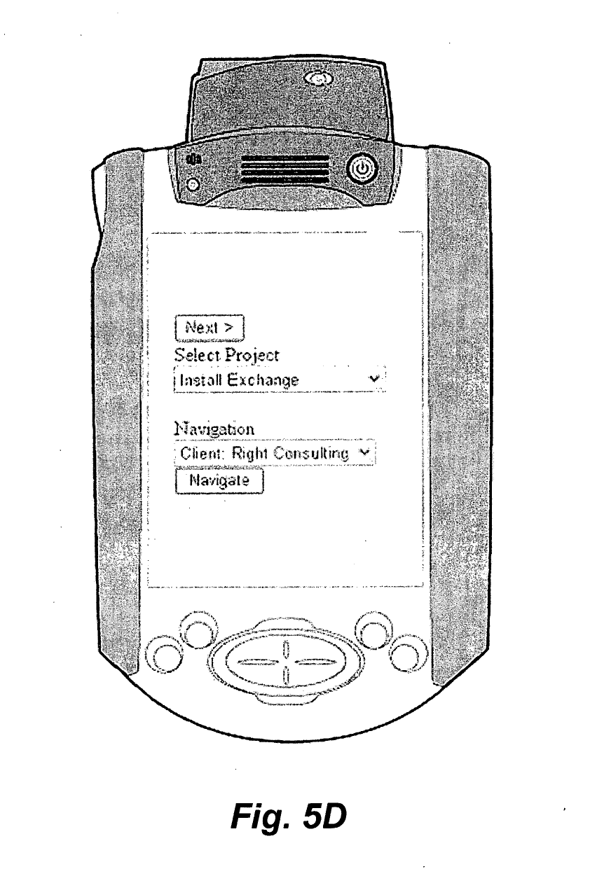

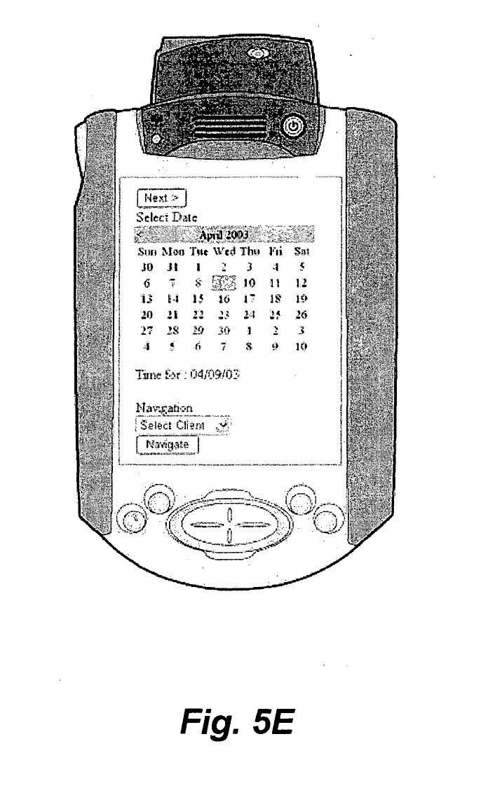

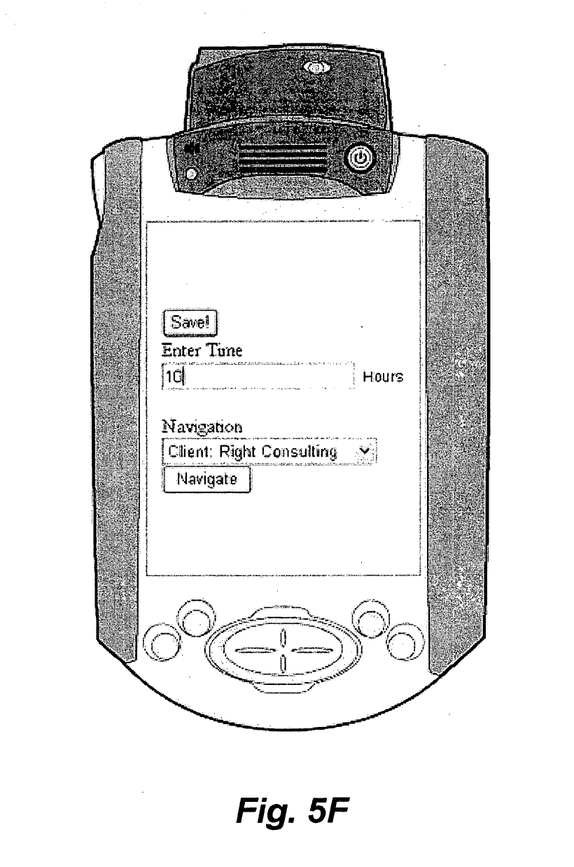

FIGS. 4A-4G illustrate the sequence of input screens presented to a mobile employee on their cellular telephone, while FIGS. 5A-5F illustrate the screens presented to an employee using a PDA. FIG. 4A illustrates a login screen presented to a mobile employee using a cell phone device. The user is provided a login name and password, provided by the administrator of the System 100 that will allow the user to log into the secured Web server 102. The user must enter a login name and then password. Once entered, a keystroke will send it to the Web server 102. The server 102 will verify that the “login name” and “password” match to the login name and password stored in the database server 106 to allow further access to the System 100.

Upon authentication of the employee, the employee enters the date of the transaction in their cell phone as shown in FIG. 4B. Upon entry of the time, and depending upon the profile for the particular employee stored in the client/employee database 106, the user is presented with a client list, which includes “Sales Automation, Inc”, as shown in FIG. 4C. The employee will only be allowed to view client names and services performed for the client that the employee works for, from a drop-down list. In addition, the employee can be limited further, if needed, to only show clients and services that the particular employee is personally associated with, as per the processes discussed above. For example, if a company has five hundred clients and performs one hundred services for each of its clients, but employee A only works of two of the five hundred clients and only performs twenty services for one client and thirty services for the other client, employee A's access the System 100 can be limited to allow only those services for those clients they are specially associated with. This will protect users from seeing all of the company's clients, if the company so desires. FIG. 4D illustrates the cell phone screen display after the employee has selected “Sales Automation, Inc” and is then prompted to go to the next screen.

Similarly, FIG. 4E illustrates the screen display prompting the employee to select a service performed for client “Sales Automation, Inc”. Upon selection of “VPN Design”, the last piece of data entered is the time duration for the selected project, the number “8” as shown in FIG. 4F. Prior to accepting the completed time transaction, the System 100 presents the employee with the entire transaction for validation as shown in FIG. 4G.

The sequence of data entry for a PDA or for any mobile computing device is similar to that of the cellular telephone user. The user logs in (FIG. 5A) with a username and password, selects a client, “Right Consulting” and a project, “Install Exchange” (FIGS. 5B-5D), a date, e.g. Apr. 9, 2003 (FIG. 5E), and time duration, “10” for the project (FIG. 5F). Upon completion of a time transaction the employee has the option to enter data for a new transaction, or to end the call.

It is to be understood that the present invention is not limited to the embodiment described above, but encompasses any and all embodiments within the scope of the following claims.

1. A time management system, comprising at least one server computer having an interface for communication over a computer network for receiving time records from mobile computing devices, and transmitting said time records to at least one network connected remote client computer, said server further comprising application program means and a memory for storing data for access by said application program means.

2. The time management system according to claim 1, wherein said memory further comprises a data structure stored in said memory, said data structure including:
employee data for authentication of each user of the system;
client data identifying each company that has users accessing the system, said client data having predefined administrative user preferences;
project data for each project authorized by each client;
project type data for encapsulating the characteristics of a number of different project types which may be selected as part of the project data; and
transaction data comprising project and time entered by a particular system user for a selected project.

3. The time management system according to claim 1, wherein said application program means comprises:
a human interface service means, for mediating requests for human interface services, said requests from human interface users resident on at least one mobile computing device, said human interface server operative to receive time reporting data from said human interface users;
a user authentication means, for validating employee and client access to said time management system;
an automatic remote client computer interface means, for transmitting said employee time records to said at least one remote client computer on a predetermined schedule; and
a request based remote client interface means, for interactive transmission of said employee time records to said at least one remote client computer.

4. The time management system according to claim 1, wherein said application program means further comprises management notification means, for presenting to the employee recommended duration times for selected projects.

5. The time management system according to claim 1, wherein said human interface service means further comprises a cell phone having an Internet connection and a web browser.

6. The time management system according to claim 1, wherein said human interface service means further comprises a Personnel Data Assistant having an Internet connection and a web browser.

7. The time management system according to claim 1, wherein said telecommunications network comprises Internet and cellular telephone networks.

8. A method for receiving time transaction data from an employee's mobile computing device and submitting the time transaction data to a remote client computer application, the method comprising:
providing a Web site system that provides web services allowing employees to enter time transaction data;
providing a data store comprising: employee data for authentication of each user of the system; client data pertaining to each company that has employees accessing the system; project data for each project authorized by each client; project type data for encapsulating the characteristics of each least one project type; and time transaction data comprising employee, date, client, and project performed; and
transmitting said time transaction data to a series of web services for further submission to said at least one client computer and authorized administrators.

9. The method of claim 8, further comprising presenting Web requests for employee project and time data, the Web page and request format based upon stored employee profile data.

10. The method of claim 8, further comprising transmitting transaction data directly to a web service without remote client interaction.

11. The method of claim 8, further comprising:
receiving from a client computer a request for data message which contains a token and extracting the token from the message requests for time transaction data from, and the transmission of time transaction data to, client applications;
using said token for marking for deletion all transactions behind said token, creating a dataset of all transactions in said data store between said token and the latest transaction, creating a new token, and identifying said dataset with said new token; and
transmitting said dataset with said new token to said at least one remote client computer.

12. The method of claim 8, further comprising notifying the employee of how long the project should take.
